(19) United States
(12) Patent Application Publication
(10) Pub. No.: US 2024/0157470 A1
(43) Pub. Date: May 16, 2024

(54) LASER PROCESSING DEVICE

(71) Applicant: KATAOKA CORPORATION, Kyoto (JP)

(72) Inventors: Etsushi KATO, Kyoto-shi (JP); Takeshi YAMAMURA, Kyoto-shi (JP); Keisuke HAYASHI, Kyoto-shi (JP)

(73) Assignee: KATAOKA CORPORATION, Kyoto (JP)

(21) Appl. No.: 18/421,370

(22) Filed: Jan. 24, 2024

Related U.S. Application Data
(63) Continuation of application No. PCT/JP2022/016724, filed on Mar. 31, 2022.

(30) Foreign Application Priority Data
Oct. 1, 2021 (JP) 2021-163016

(51) Int. Cl. B23K 26/046; B23K 26/06; B23K 26/073; B23K 26/082; B23K 26/21

(52) U.S. Cl. CPC B23K 26/046; B23K 26/0604; B23K 26/0648; B23K 26/073; B23K 26/082; B23K 26/21

(57) ABSTRACT

A laser processing device 0 includes a combiner unit 3 configured to superimpose a plurality of laser beams L1 and L2 having different wavelengths on the same optical axis; a focus shifter unit 4 configured to adjust a focal length of the laser beams L1 and L2 superimposed by the combiner unit 3; and a Galvano scanner unit 5 located downstream of the focus shifter unit 4 and configured to change a direction of the optical axis of the laser beams L1 and L2 traveling toward a processing object, and the adjustment in the focal length performed by the focus shifter unit 4 is synchronized with the change in the direction of the optical axis performed by the Galvano scanner unit 5.

### REFERENCE TO RELATED APPLICATIONS

This is a continuation application of International Application No. PCT/JP2022/016724 filed on Mar. 31, 2022, which claims priority from Japanese Patent Application No. 2021-163016 filed on Oct. 1, 2021. The entire contents of the aforementioned applications are incorporated herein by reference.

### BACKGROUND ART

As a laser processing device that irradiates any portion of a processing object with a laser beam, a laser processing device that displaces an optical axis of the laser beam using a Galvano scanner is known. The Galvano scanner includes a mirror that reflects the laser beam, and a servo motor or a stepping motor that rotates the mirror at a high speed and with high accuracy.

When a direction of the mirror of the Galvano scanner and a direction of an optical axis of the laser beam are changed, an angle at which the optical axis of the laser beam and the processing object intersect changes, and an optical path length from the mirror to the processing object increases or decreases at the same time. Therefore, an fθ lens or a telescope lens is generally interposed between the mirror of the Galvano scanner and the processing object, and a focal point of the laser beam passing through the lens is normally and appropriately focused on an upper surface of the processing object (see, for example, JP 5519123 B).

### SUMMARY

In a welding processing of a copper plate, a copper terminal, or the like, it may be desired to superimpose two or more types of laser beams having different wavelengths and irradiate any portion of a processing object. Typically, a blue laser beam and an infrared laser beam are superimposed, and then emitted to a welding portion of the processing object. Copper well absorbs blue light, but an output of an existing blue laser beam source is not sufficiently large, so that a high-output infrared laser beam source is used together.

As described above, the Galvano scanner is usually used as the fθ lens. However, in a lens that transmits the laser beam, a chromatic aberration is inevitably generated based on universal physical laws (because a refractive index of light depends on a wavelength of the light). Therefore, when the processing object is irradiated with a plurality of superimposed laser beams having different wavelengths via the fθ lens, an irradiation position of the laser beam having a certain wavelength and an irradiation position of the laser beam having another wavelength that is superimposed on the laser beam having the certain wavelength are deviated on the processing object. Due to the deviation, there is a concern that a desired laser processing or processing result cannot be obtained.

Accordingly, in the related art, the Galvano scanner cannot be used, and instead, an XY stage (supporting the processing object or supporting a laser processing nozzle) is used to move the processing object relative to the optical axis of the laser beam.

A lens made of a glass material having a relatively small chromatic aberration is also present, but when the laser beam is absorbed, a change in refractive index occurs as a thermal lens effect, and thus it is practically difficult to apply the lens to a high-output laser of a kW class.

An object of the present disclosure is to provide a laser processing device capable of superimposing a plurality of laser beams having different wavelengths and suitably irradiating any portion of a processing object via a Galvano scanner.

A laser processing device according to the present disclosure includes a combiner unit configured to superimpose a plurality of laser beams having different wavelengths on the same optical axis; a focus shifter unit configured to adjust a focal length of the laser beams superimposed by the combiner unit; and a Galvano scanner unit located downstream of the focus shifter unit and configured to change a direction of the optical axis of the laser beams traveling toward a processing object, and the adjustment in the focal length performed by the focus shifter unit is synchronized with the change in the direction of the optical axis performed by the Galvano scanner unit.

It is ideal that a lens configured to allow a laser beam to pass therethrough does not exist between the Galvano scanner unit and the processing object. However, a lens that transmits the laser beams (obtained by superimposing the plurality of laser beams having different wavelengths) may be interposed between the Galvano scanner unit and the processing object as long as the chromatic aberration (including a thermal lens effect) occurs only to an extent that a deviation in irradiation positions of the laser beams can be ignored.

The focus shifter unit includes a lens that moves forward and backward along the optical axis of the laser beams to adjust a focal length of the laser beams. If the combiner unit is disposed downstream of the lens of the focus shifter unit, the plurality of laser beams are superimposed by the combiner unit after the focal length is adjusted by the lens. Accordingly, a problem of the chromatic aberration occurring in the lens can be reliably avoided.

The focus shifter unit includes a lens for expanding a diameter of the laser beams superimposed by the combiner unit and a lens for reducing a diameter of the laser beams passing through the lens, and a relative distance between the two lenses along the optical axis of the laser beams are expanded or reduced in synchronization with the change in the direction of the optical axis performed by the Galvano scanner unit.

The laser processing device according to the present disclosure is used, for example, to perform welding by emitting a laser beam to the processing object. In the laser processing device, the processing object is irradiated with a laser beam, that is obtained by superimposing a blue laser beam and an infrared laser beam, through the combiner unit, the focus shifter unit, and the Galvano scanner unit.

### BRIEF DESCRIPTION OF DRAWINGS

FIG. 1 is a diagram schematically showing a configuration of a laser processing device according to an embodiment of the present disclosure.

FIG. 2A and FIG. 2B are diagrams illustrating a function of a focus shifter unit of the laser processing device.

FIG. 3 is a diagram illustrating a function of a Galvano scanner unit of the laser processing device.

FIG. 4 is a diagram schematically showing a configuration of a laser processing device according to a modification of the present disclosure.

FIG. 5 is a diagram schematically showing a configuration of a laser processing device according to a modification of the present disclosure.

### DESCRIPTION

An embodiment of the present disclosure will be described with reference to the drawings. A laser processing device 0 according to the present embodiment can superimpose a plurality of laser beams L1 and L2 having different wavelengths and then irradiate any portion of a processing object (or an object to be processed or a workpiece) W with the superimposed laser beams L1 and L2.

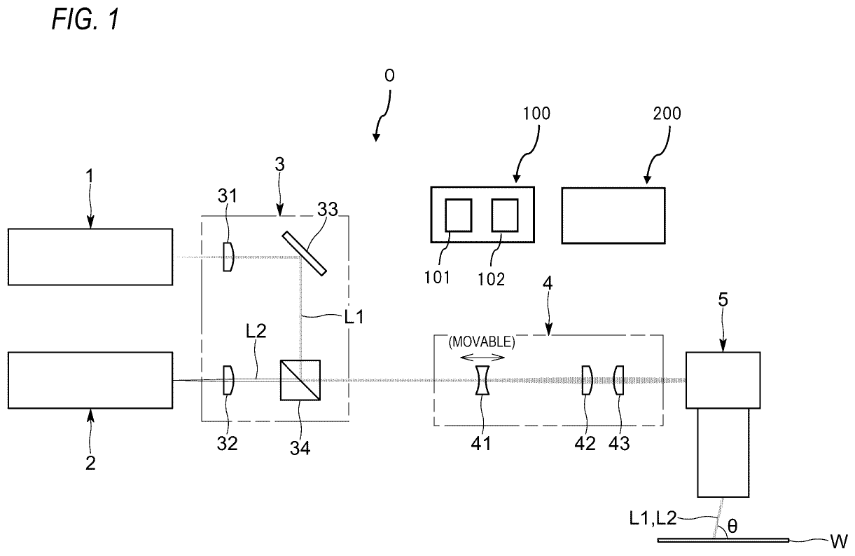

The laser processing device 0 of the present embodiment shown in FIGS. 1 to 3 includes laser beam sources 1 and 2 that output a plurality of laser beams L1 and L2 having different wavelengths, respectively; a combiner unit 3 that superimposes the plurality of laser beams L1 and L2 supplied from the laser beam sources 1 and 2 on the same optical axis; a focus shifter unit 4 that is located downstream of the combiner unit 3 and adjusts a focal length of the laser beams L1 and L2 superimposed on the same optical axis; a Galvano scanner unit 5 that is located downstream of the focus shifter unit 4 and changes a direction of the optical axis of the laser beams L1 and L2 traveling toward the processing object W, a memory unit 200, and a controller 100. The controller 100 includes a CPU (Central Processing Unit) 101 and a RAM (Random Access Memory) 102, which serves as a working memory. The memory unit 200 is a so-called auxiliary storage device and includes non-volatile memory such as HDD, SSD, ROM (Read Only Memory) and flash memory. Various data, such as computer programs for controlling the laser processing device 0, are stored in the memory unit 200. The controller 100 is connected with the focus shifter unit 4 and the Galvano scanner unit 5, and is configured to control the focus shifter unit 4 and the Galvano scanner unit 5. The CPU 101 of the control unit 100 loads and executes the computer program stored in the memory unit 200 into the working memory RAM 212. which is the working memory, and executes the computer program,

The laser processing device 0 is mainly assumed to perform a laser welding processing in which a copper plate that is the processing object W, a copper contacts on the processing object W, or the like are irradiated with the laser beams L1 and L2 and welded. The laser processing device 0 includes, for example, the light source 1 that outputs the blue laser beam L1 having a wavelength of about 450 nm and the light source 2 that outputs the near-infrared laser beam L2 having a wavelength of about 1070 nm, and first superimposes, in the combiner unit 3, the laser beams L1 and L2 supplied from the respective light sources 1 and 2.

As shown in FIG. 1, the combiner unit 3 includes, for example, lenses (collimation lenses or the like) 31 and 32 for collimating the laser beams L1 and L2 supplied from the light sources 1 and 2, respectively, and mirrors (including a beam splitter, a half mirror, a combiner, or the like) 33 and 34 necessary for aligning optical axes of the laser beams L1 and L2 passing through the lenses 31 and 32. Of course, the combiner unit 3 may include optical elements, optical fibers, and the like other than those described above. The wavelengths of the laser beams L1 and L2 supplied from the light sources 1 and 2 are not particularly limited. Instead of the blue laser beam L1, a green laser beam may be adopted, or a near-infrared laser beam having a wavelength (for example, about 808 nm) different from that of the laser beam L2 may be adopted. In addition, three or more types of laser beams having different wavelengths may be superimposed in the combiner unit 3.

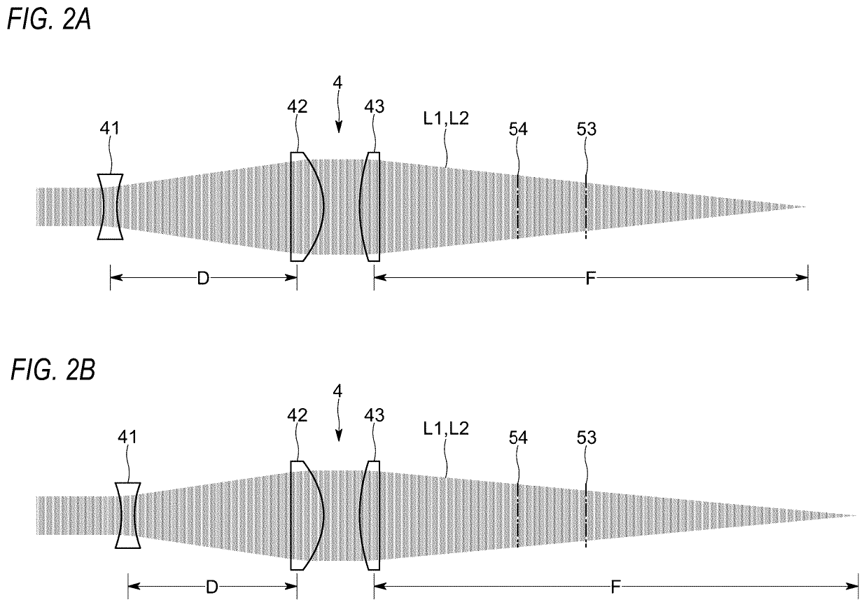

As shown in FIG. 2A and FIG. 2B, the focus shifter unit 4 includes a lens (a concave lens, particularly, a biconcave lens, or the like) 41 that expands a diameter of the laser beams L1 and L2 superimposed on the combiner unit 3, and lenses (a plurality of convex lenses, particularly, plano-convex lenses that serve as a collimation lens and a condensing lens) 42 and 43 that reduce the diameter of the laser beams L1 and L2 passing through the lens 41. Of course, the focus shifter unit 4 may include optical elements, optical fibers, and the like other than those described above.

The focus shifter unit 4 variably adjusts a focal length F of the laser beams L1 and L2 emitted from the combiner unit 3. Therefore, in an example shown in FIG. 2A and FIG. 2B, at least one of the concave lens 41 and/or the convex lens 42 is supported by a linear motor truck or another suitable drive mechanism and can move forward and backward along an optical axis direction in order to make a relative distance D between the concave lens 41 and the convex lens 42 along the axes of the laser beam L1 and the laser beam L2 variably adjustable. The condensing lens 43 at a terminal end does not have to move forward or backward along the optical axis direction.

As shown in FIG. 2A, as the distance D between the concave lens 41 and the convex lens 42 decreases, the focal length F of the laser beams L1 and L2 passing through the lenses 41, 42, and 43 of the focus shifter unit 4 increases. That is, the focal points of the laser beams L1 and L2 are separated from the lens 43 at the terminal end of the focus shifter unit 4.

Conversely, as illustrated in FIG. 2B, as the distance D between the concave lens 41 and the convex lens 42 increases, the focal length F of the laser beams L1 and L2 passing through the lenses 41, 42, and 43 of the focus shifter unit 4 decreases. That is, the focal points of the laser beams L1 and L2 approach the lens 43 at the terminal end of the focus shifter unit 4.

Chromatic aberration may also occur in the lenses 41, 42, and 43. Therefore, in practice, the focal points of the superimposed laser beams L1 and L2 are made to match by adjusting positions of the lens 31 and/or the lens 32 through which the laser beams L1 and L2 output from the laser beam sources 1 and 2 pass.

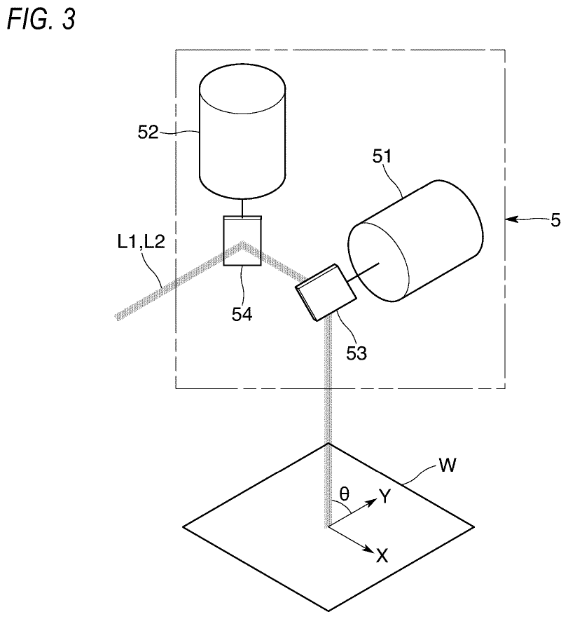

As shown in FIG. 1 and FIG. 3, the Galvano scanner unit 5 is a known unit that rotates mirrors 53 and 54, that reflect the laser beams L1 and L2 emitted from the focus shifter unit 4, via drive mechanisms 51 and 52 such as servo motors, stepping motors, and the like. In short, the Galvano scanner unit 5 can change the direction of the optical axis of the laser beams L1 and L2 reflected by the mirrors 53 and 54. The Galvano scanner unit 5 according to the present embodiment includes both X-axis Galvano scanner including the drive mechanism 51 and the mirror 53 that change the optical axis of the laser beams L1 and L2 traveling toward the processing object W along an X-axis direction of the processing object W, and Y-axis Galvano scanner including the drive mechanism 52 and the mirror 54 that change the optical axis of the laser beams L1 and L2 along a Y-axis direction of the processing object W. The Galvano scanner unit 5 can two-dimensionally control an irradiation position of the laser beams L1 and L2 on the processing object W by scanning the processing object W with the laser beams L1 and L2 two-dimensionally in XY directions.

The laser processing device 0 of the present embodiment is characterized in that the adjustment in the focal length F performed by the focus shifter unit 4 is synchronized with the change in the direction of the optical axis performed by the Galvano scanner unit 5.

The closer an angle θ of the optical axis of the laser beams L1 and L2 passing through the mirrors 53 and 54 of the Galvano scanner unit 5 with respect to the processing object W is to vertical, the shorter an optical path length from the mirror 53 to the processing object W is. Thus, the controller 100 synchronously controls the focus shifter unit 4 and the Galvano scanner unit 5 such that the focal length F realized by the focus shifter unit 4 becomes shorter as the angle θ of the axis of the laser beam L1 and L2 with respect to the processing object W becomes closer to vertical (90°).

In other words, the optical path length from the mirror 53 to the processing object W becomes longer as the angle θ of the optical axis of the laser beams L1 and L2 passing through the mirrors 53 and 54 of the Galvano scanner unit 5 with respect to the processing object W is inclined from the vertical. As a result, the focus shifter unit 4 and the Galvano scanner unit 5 are synchronously controlled such that the focal length F realized by the focus shifter unit 4 becomes longer as the angle θ of the axis of the laser beams L1 and L2 with respect to the processing object W is inclined (away from 90°).

The laser beams L1 and L2 can be emitted to any portion of the processing object W through the synchronous control on the lenses 41 and 42 of the focus shifter unit 4 and the mirrors 53 and 54 of the Galvano scanner unit 5, and the focal points of the laser beams L1 and L2 can be accurately adjusted to a desired processing target surface of the processing object W.

It is desirable that a lens (fθ lens or the like) that allows the laser beams L1 and L2 to pass therethrough does not exist between the mirrors 53 and 54 of the Galvano scanner unit 5 and the processing object W. Thus, a problem of the chromatic aberration that occurs when the laser beams L1 and L2, whose optical axis direction is manipulated by the Galvano scanner unit 5, pass through the lenses can be reliably avoided. That is, a deviation does not occur between a position on the processing object W at which the laser beam L1 having a certain wavelength hits and a position on the processing object W at which the laser beam L2 superimposed on the laser beam L1 hits. Accordingly, a desired laser processing or processing result can be obtained.

However, a lens that transmits the laser beams L1 and L2 may be interposed between the mirrors 53 and 54 of the Galvano scanner unit 5 and the processing object W as long as the chromatic aberration occurs only to an extent that the deviation in irradiation positions of the laser beams L1 and L2 can be ignored.

The present disclosure is not limited to the embodiment described above in detail. In the above embodiment, the biconcave lens 41, the collimation lens 42, and the condensing lens 43 that are elements of the focus shifter unit 4 are located downstream of the mirrors 33 and 34 that are elements of the combiner unit 3, but an arrangement of the optical elements 33, 34, 41, 42 and 43 is not limited to that shown in FIG. 1.

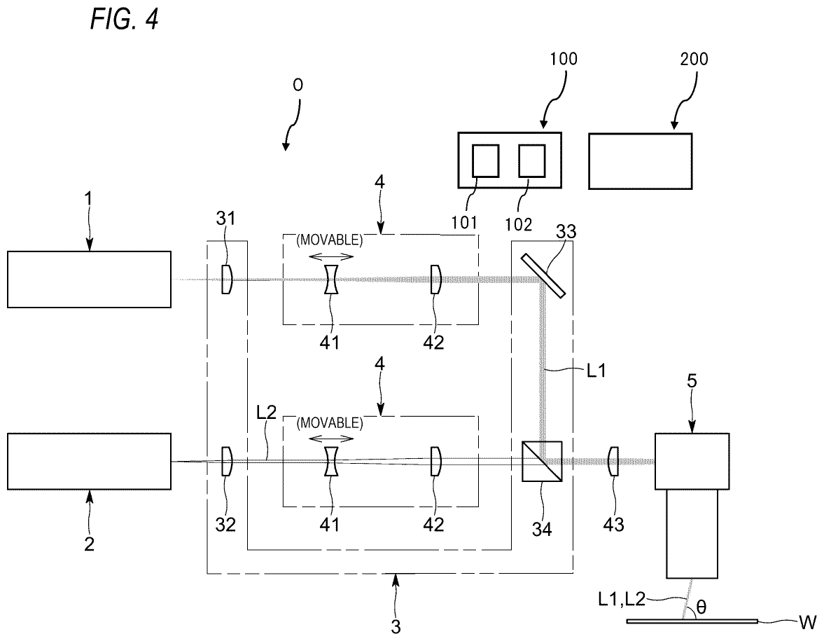

In a modification of the present disclosure shown in FIG. 4, the biconcave lens 41 and the collimation lens 42 are arranged on each of the optical axis of the laser beam L1 output from the laser beam source 1 and the optical axis of the laser beam L2 output from the laser beam source 2. In short, there are two biconcave lens 41 and two collimation lenses 42.

Then, the laser beam L1 and the laser beam L2 that each pass through the biconcave lens 41 and the collimation lens 42 are superimposed on each other via the mirrors 33 and 34 that are elements of the combiner unit 3, then are finally condensed by passing through the condensing lens 43, and are input to the Galvano scanner unit 5.

In the modification shown in FIG. 4, the relative distance D between the concave lens 41 and the convex lens 42 along each of the axes of the laser beams L1 and L2 can also be variably adjusted as in the above embodiment. Therefore, at least one of the concave lens 41 and/or the convex lens 42 on each of the axes of the laser beams L1 and L2 is supported by a linear motor truck or another suitable drive mechanism and can move forward and backward along an optical axis direction.

For example, the concave lens 41 existing on the optical axis L1 and the concave lens 41 existing on the optical axis L2 are simultaneously controlled in one axis, and the concave lenses 41 can move forward and backward along the optical axis direction. Positions of the convex lenses 42 on the optical axes L1 and L2 along the optical axis direction are adjusted in advance according to the wavelengths of the laser beams L1 and L2.

It is needless to say that the adjustment in the relative distance D, in other words, the adjustment in the focal length F performed by the focus shifter unit 4 is synchronized with the change in the direction of the optical axis performed by the Galvano scanner unit 5.

In the example shown in FIG. 1, after the laser beams L1 and L2 having different wavelengths are superimposed by the mirrors 33 and 34 of the combiner unit 3, the focal lengths thereof are adjusted by the lenses 41, 42, and 43 of the focus shifter unit 4. On the other hand, in the modification shown in FIG. 4, after the focal lengths of the laser beams L1 and L2 are each adjusted by the lenses 41 and 42 of the focus shifter unit 4, the laser beams L1 and L2 are superimposed by the mirrors 33 and 34 of the combiner unit 3. Accordingly, the occurrence of chromatic aberration in the lenses 41 and 42 can be suitably avoided, and the laser beams L1 and L2 can be more accurately emitted to a desired irradiation position on the processing object W using the Galvano scanner 5.

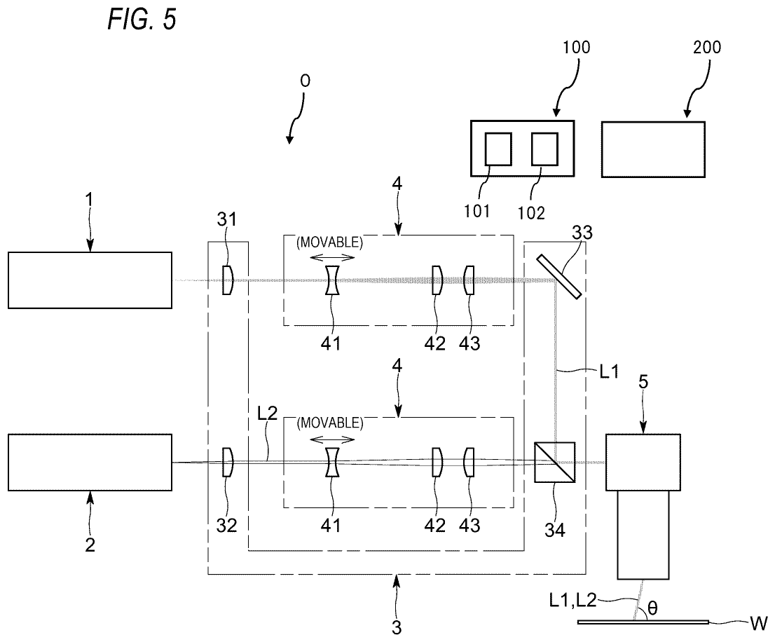

In a modification of the present disclosure shown in FIG. 5, the biconcave lens 41, the collimation lens 42, and the condensing lens 43 are arranged on each of the optical axis of the laser beam L1 output from the laser beam source 1 and the optical axis of the laser beam L2 output from the laser beam source 2. In short, there are two biconcave lenses 41, two collimation lenses 42, and two condensing lenses 43.

Then, the laser beam L1 and the laser beam L2 that each pass through the biconcave lens 41, the collimation lens 42, and the condensing lens 43 are superimposed via the mirrors 33 and 34 that are elements of the combiner unit 3, and then are input to the Galvano scanner unit 5.

In the modification shown in FIG. 5, the relative distance D between the concave lens 41 and the convex lens 42 along each of the axes of the laser beams L1 and L2 can also be variably adjusted as in the above embodiment. Therefore, at least one of the concave lens 41 and/or the convex lens 42 on each of the axes of the laser beams L1 and L2 is supported by a linear motor truck or another suitable drive mechanism and can move forward and backward along an optical axis direction.

For example, the concave lens 41 existing on the optical axis L1 and the concave lens 41 existing on the optical axis L2 are simultaneously controlled in one axis, and the concave lenses 41 can move forward and backward along the optical axis direction. Positions of the convex lenses 42 on the optical axes L1 and L2 along the optical axis direction are adjusted in advance according to the wavelengths of the laser beams L1 and L2.

It is needless to say that the adjustment in the relative distance D, in other words, the adjustment in the focal length F performed by the focus shifter unit 4 is synchronized with the change in the direction of the optical axis performed by the Galvano scanner unit 5.

In the modification shown in FIG. 5, after the focal lengths of the laser beams L1 and L2 are each adjusted by the lenses 41, 42 and 43 of the focus shifter unit 4, the laser beams L1 and L2 are superimposed by the mirrors 33 and 34 of the combiner unit 3. Accordingly, the occurrence of chromatic aberration in the lenses 41, 42 and 43 can be suitably avoided, and the laser beams L1 and L2 can be more accurately emitted to a desired irradiation position on the processing object W using the Galvano scanner 5.

In addition, the specific configuration of each part can be variously modified without departing from the spirit of the present disclosure.

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents.

What is claimed is:

1. A laser processing device comprising:
a combiner unit configured to superimpose a plurality of laser beams having different wavelengths on the same optical axis;
a focus shifter unit configured to adjust a focal length of the laser beams superimposed by the combiner unit;
a Galvano scanner unit located downstream of the focus shifter unit and configured to change a direction of the optical axis of the laser beams traveling toward a processing object; and
a controller configured to synchronously control the adjustment in the focal length performed by the focus shifter unit and the change in the direction of the optical axis performed by the Galvano scanner unit.

2. The laser processing device according to claim 1,
wherein a lens configured to allow a laser beam to pass therethrough does not exist between the Galvano scanner unit and the processing object.

3. The laser processing device according to claim 1,
wherein the focus shifter unit includes a lens that moves forward and backward along the optical axis of the laser beams to adjust a focal length of the laser beams, and
wherein the combiner unit is disposed downstream of the lens of the focus shifter unit.

4. The laser processing device according to claim 1,
wherein the focus shifter unit includes a lens for expanding a diameter of the laser beams superimposed by the combiner unit and a lens for reducing a diameter of the laser beams passing through the lens, and a relative distance between the two lenses along the optical axis of the laser beams are expanded or reduced in synchronization with the change in the direction of the optical axis performed by the Galvano scanner unit.

5. The laser processing device according to claim 1,
wherein the laser processing device is configured to perform welding by emitting a laser beam to the processing object, and
wherein a laser beam, that is obtained by superimposing a blue laser beam and an infrared laser beam, is emitted to the processing object through the combiner unit, the focus shifter unit, and the Galvano scanner unit.
